(19) United States
(12) Patent Application Publication
(10) Pub. No.: US 2007/0243758 A1
(43) Pub. Date: Oct. 18, 2007

(54) Clasp structure for a connector

(75) Inventor: Kuang-Hua Shiu, Jhongli City (TW)

Correspondence Address: Troxell Law Office Pllc, Suite 1404, 5205 Leesburg Pike, Falls Church, VA, 22041, US

(73) Assignee: Singatron Enterprise Co., Ltd.

(21) Appl. No.: 11/403,886

(22) Filed: Apr. 14, 2006

(51) Int. Cl. H01R 13/73

(52) U.S. Cl. 439/554

(57) ABSTRACT

The present invention provides a clasp structure for a connector, wherein a connector is structured from a base, terminals and one or more than one protective cover disposed exterior of the base. Moreover, protruding ribs are formed on at least one side surface of the base. Such a configuration facilitates clasping the connector into grooves of a circuit board by means of the protruding ribs, thereby achieving the objective of fixedly installing the connector.

### BACKGROUND OF THE INVENTION

(a) Field of the Invention

The present invention relates to a clasp structure for a connector, and more particularly to a connector configuration that facilitates fixedly clasping the connector and that has a reduced size.

(b) Description of the Prior Art

FIGS. 1 and 2 show a prior art connector A, wherein a groove A3 is defined at a front end of a base A1, the groove A3 being formed between symmetrically disposed protruding rings A2. When installing the connector A to a circuit board B for use thereof, a processor must align the groove A3 with edge indentations C1 of a case C for clamping therein in order to achieve the objective of fixing the assembly. However, such a configuration is inconvenient to assembly and difficulty to install. Furthermore, because of the disposition of the groove A3 of the connector A, thus, body configuration of the connector A has a relatively large size, which results in relatively high cost expenditure.

Hence, the inventor of the present invention proposes to resolve and surmount existent technical difficulties to eliminate the aforementioned shortcomings of prior art.

### SUMMARY OF THE INVENTION

The present invention provides a clasp structure for a connector, and more particularly provides a connector configuration that facilitates fixedly clasping the connector and that has a reduced size, which not only saves on cost expenditure, but also has relatively wide-ranging application.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of prior art.

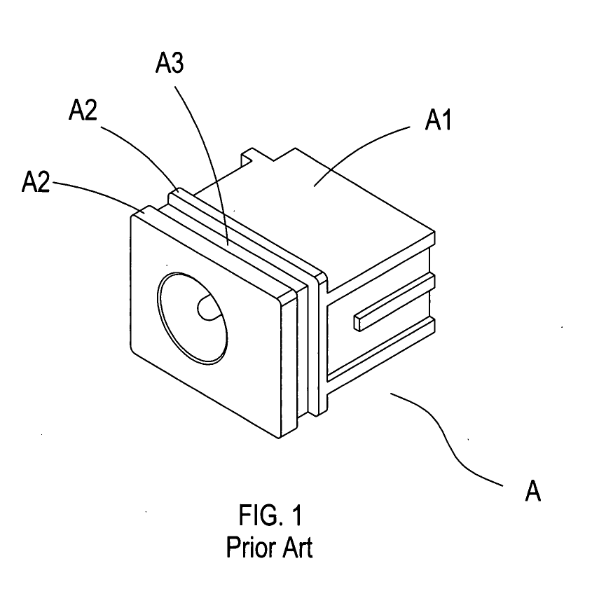

FIG. 2 shows an exploded elevational view of prior art.

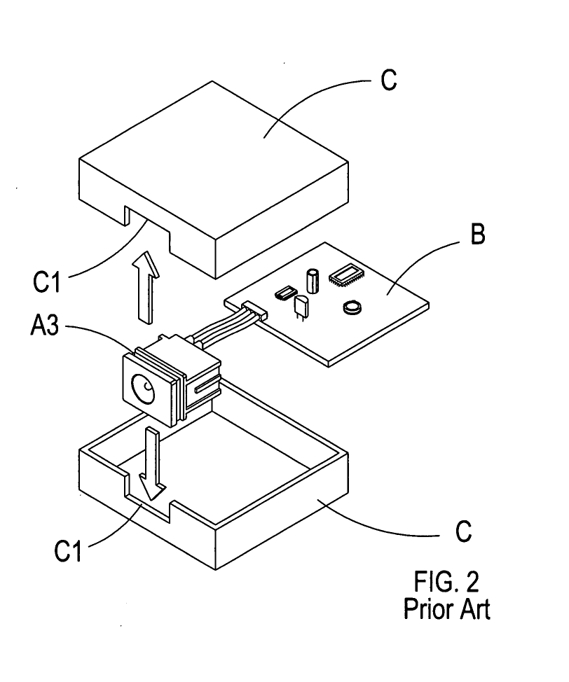

FIG. 3 shows an elevational view according to the present invention.

FIG. 4 shows an exploded elevational view according to the present invention.

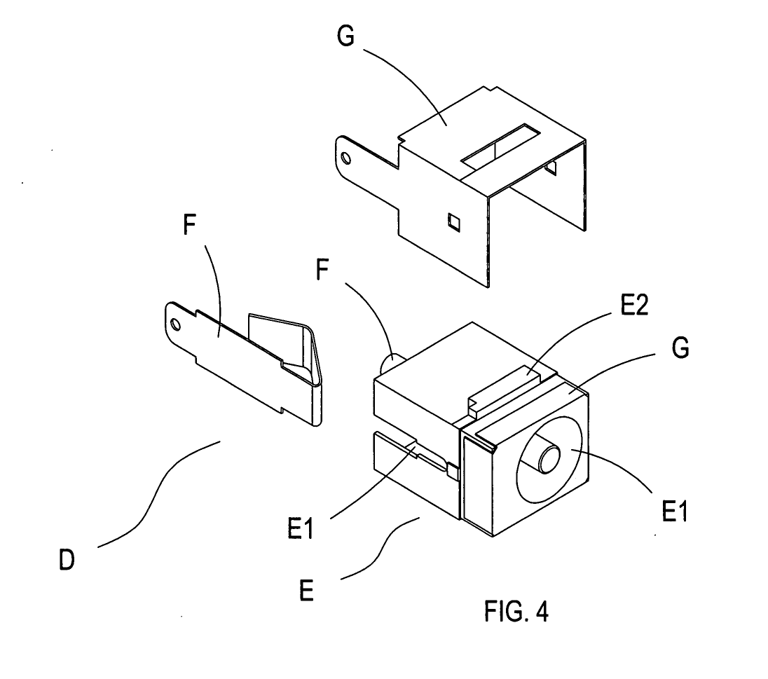

FIG. 5 shows a first schematic view of an embodiment according to the present invention.

FIG. 6 shows a second schematic view of the embodiment according to the present invention.

### DETAILED DESCRIPTION OF THE PREFERRED EMBODIMENTS

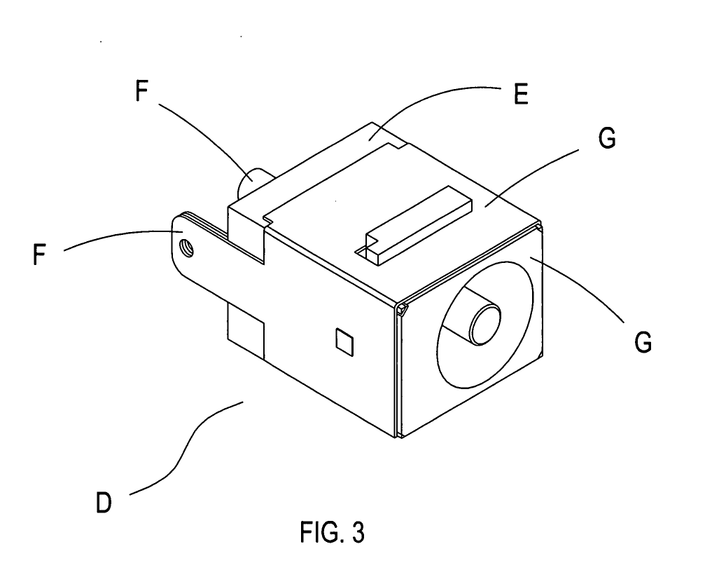

Referring to FIG. 3, which shows a clasp structure for a connector of the present invention, wherein a connector D is structured to comprise a base E, in which a plurality of holes E1 are defined, one or more than one terminal F configured corresponding to the plurality of holes E1 and one or more than one protective cover G. disposed exterior of the base E. Protruding ribs E2 are respectively formed on an upper side surface and a lower side surface of the base E.

The protective covers G serve as earthing devices for the connector D, thereby reducing noise and interference with the connector D. Moreover, the protruding ribs E2 enable achieving the objective of fixedly installing the connector D.

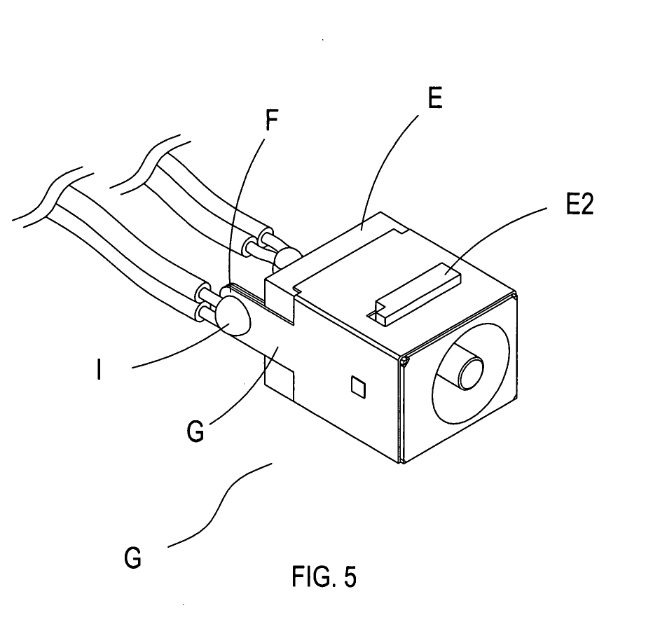

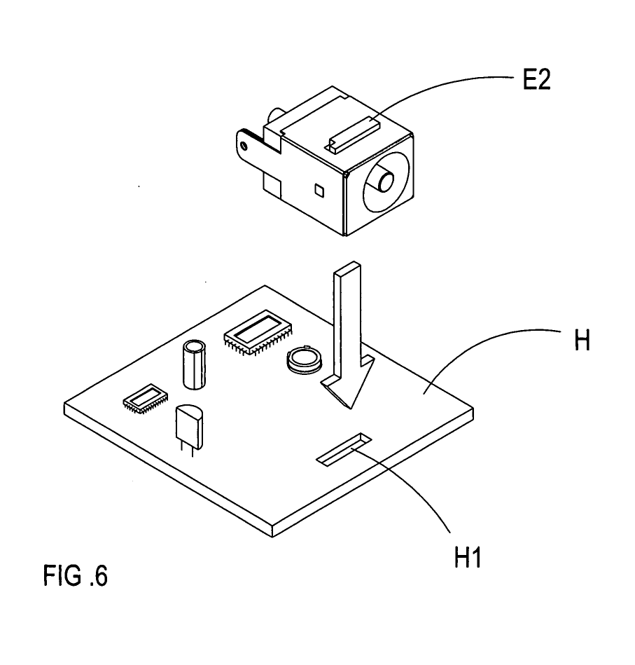

Referring to FIGS. 5 and 6, which show an embodiment of the clasp structure of the present invention, wherein the connector D is installed on a circuit board H, and the protective cover G is connected to one of the earth terminals F using electric welding 1, which reduces noise and interference with the connector D. Furthermore, the protruding rib E2 formed on the upper side surface of the base E clasps into a groove H1 defined in the circuit board H, thereby achieving the objective of fixedly installing the connector D.

The protruding rib E2 can be further formed on a left side surface and a right side surface of the base E of the connector D. Furthermore, the protruding ribs E2 can be further formed on side edges of the base E of the connector D. The side edges are at the junction of the upper side surface and the left side surface, at the junction of the upper side surface and the right side surface, at the junction of the lower side surface and the left side surface, at the junction of the lower side surface and the right side surface, at the junction of the upper side surface and a front side surface, at the junction of the upper side surface and a rear side surface, at the junction of the lower side surface and the front side surface and at the junction of the lower side surface and the rear side surface.

In order to better explicitly disclose advancement and practicability of the present invention, a comparison with prior art is described hereinafter:

Shortcomings of Prior Art

1. Relatively large body size.

2. Because of shortcoming 1, thus, cost expenditure is relatively high.

3. Fixedly clasping the prior art connector is relatively difficult.

Advantages of the Present Invention

1. Relatively small body size.

2. Because of advantage 1, thus, cost expenditure is substantially reduced.

3. Fixedly clasping the connector D is convenient and fast.

4. Substantially wide-ranging application.

5. Provided with advancement and practicability.

6. Enhances commercial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A clasp structure for a connector comprising at least a base, one or more than one terminal disposed on the base and one or more than one protective cover disposed exterior of the base; and
a protruding rib is formed on at least one side surface of the base, and the protruding rib is configured to fixedly clasp into a groove in a circuit board, wherein the groove directly underlies the at least one side surface having a protruding rib thereby achieving the objective of fixedly installing the connector.

2. (canceled)

3. The clasp structure for a connector according to claim 1, wherein the side surfaces are an upper side surface, a lower side surface, a left side surface and a right side surface of the base.

4. The clasp structure for a connector according to claim 1, wherein the protruding ribs are further formed on at least one side edge of the base.

5. The clasp structure for a connector according to claim 4, wherein the side edges are at the junction of the upper side surface and the left side surface, at the junction of the upper side surface and the right side surface, at the junction of the lower side surface and the left side surface, at the junction of the lower side surface and the right side surface, at the junction of the upper side surface and a front side surface, at the junction of the upper side surface and a rear side surface, at the junction of the lower side surface and the front side surface and at the junction of the lower side surface and the rear side surface.
